(19) United States
(12) Patent Application Publication
(10) Pub. No.: US 2012/0117380 A1
(43) Pub. Date: May 10, 2012

(54) Method for Granting Authorization to Access a Computer-Based Object in an Automation System, Computer Program, and Automation System

(75) Inventors: Harald Herberth, Oberasbach (DE); Ulrich Kröger, Kaiserslautern (DE); Allan Sobihard, Bratislava (SK)

(73) Assignee: Siemens Aktiengesellschaft, Munchen (DE)

(21) Appl. No.: 13/061,893

(22) PCT Filed: Sep. 2, 2009
(86) PCT No.: PCT/EP09/61328

§ 371 Date: Mar. 28, 2011

(30) Foreign Application Priority Data
Sep. 2, 2008 (EP) 08015433.9

(51) Int. Cl. H04L 29/06; G06F 21/00; H04L 9/32

(52) U.S. Cl. 713/155

(57) ABSTRACT

An identifier is determined for a control program, and the identifier is encrypted based on a private digital key associated with a control and monitoring unit of the automation system to grant authorization to access a computer-based object in an automation system. A first service of the automation system is provided based on the computer-based object, and a second service of the automation system is provided based on the control program. The encrypted identifier is decrypted when being transmitted to an authentication service and is verified by the authentication service. If the verification process has been successful, the authentication service transmits a temporarily valid token to the second service. When the control program requests access to the computer-based object, the token is transmitted to the first service for checking purposes. The control program is granted access to the computer-based object if the result of the checking process is positive.

### CROSS-REFERENCE TO RELATED APPLICATIONS

This is a U.S. national stage of International Application No. PCT/EP2009/061328, filed on 2 Sep. 2009. This patent application claims the priority of European Patent Application No. 08015433.9, filed 2 Sep. 2008, the entire content of which application is incorporated herein by reference.

### BACKGROUND OF THE INVENTION

1. Field of the Invention

The present invention relates to automation engineering and, more particularly, to a method for granting access authorization for a computer-based object in an automation system.

2. Description of the Related Art

Due to a constantly increasing significance for information technology for automation systems, methods for protecting networked system components, such as monitoring, control and regulatory devices, sensors and actuators, against unauthorized access are becoming increasingly important. In comparison with other areas of application for information technology, data integrity has a particularly high level of importance in automation engineering. Particularly when capturing, evaluating and transmitting measurement and control data, it is necessary to ensure that complete and unaltered data are available. Intentional or unintentional alterations, or alterations caused by a technical error, must be avoided. Furthermore, particular demands in automation engineering for safety-related methods result from message traffic with comparatively many, but relatively short messages. It is additionally necessary to take account of realtime capability in an automation system and in its system components.

Particularly in automation systems, which are based on service-oriented architectures, it is frequently necessary to apply very differentiated security and access guidelines for services provided therein. Here, security and access guidelines need to be applied not only in relation to users but also in relation to services which resort to other services. As a result, software authentication is very important in such areas of application. In particular, there are requirements in this case regarding fast and effective identification and the granting of access rights for a multiplicity of software modules. Previous solutions are geared toward explicit implementation of software authentication methods. This has the drawback that appropriate authentication methods need to be permanently integrated into software modules, which either require access to resources that are to be protected or provide the resources. Alternative known approaches to a solution provide for software modules implementing authentication methods to be statically or dynamically linked to the software modules that require or provide resources which are to be protected. If the linking is effected dynamically, there is at least one opportunity to control this by means of configuration.

### SUMMARY OF THE INVENTION

It is therefore an object of the invention to provide a fast and effective method for granting access authorization for a computer-based object in an automation system and of specifying a suitable technical implementation for the method.

This and other objects and advantages are achieved in accordance with the invention by a method, a computer program and by an automation system, wherein access authorization for a computer-based object in the automation system is granted by initially ascertaining an identifier for a control program and encrypting the identifier using a private digital key associated with a control and monitoring unit of the automation system.

This can be done a single time for the control program and does not need to be repeated. The computer-based object is used to provide a first service, and the control program is used to provide a second service, from the automation system, preferably within a service-oriented architecture. Service-oriented architectures (SOA) are geared toward structuring services in complex organizational units and making these structured services available to a multiplicity of users. Here, for example, available components of a data processing system, such as programs, databases, servers or websites, are coordinated such that efforts provided by the components are combined to form services and are made available to authorized users. Service-oriented architectures allow application integration by concealing the complexity of individual subcomponents of a data processing system behind standardized interfaces. This in turn allows access authorization regulations to be simplified.

By way of example, computer-based objects are—without restricting the general nature of this term—operating systems, control or application programs, services provided by operating systems, control or application programs, service features, functions or procedures, access rights to peripheral devices and data located on a storage medium. In this context, functions or procedures particularly also comprise enabling access authorizations in an automation system. By way of example, a computer can be understood to mean PCs, notebooks, servers, PDAs, mobile phones, and control and regulatory modules, sensors or actuators in automation, vehicle, communication or medical engineering—in general terms devices in which computer programs run.

In accordance with the invention, the encrypted identifier is decrypted upon transmission to an authentication service and is verified by the authentication service. The authentication service transmits a token with at least fixed-term validity to the second service if verification is successful. When access to the computer-based object is requested, the token is transmitted by the control program to the first service for checking. If the result of the check is positive, access to the computer-based object is granted to the control program, preferably by an authorization service. The encrypted identifier can be transmitted to the authentication service as part of a service call initiated by the second service. Correspondingly, the token can be transmitted to the first service as part of a service call initiated by the second service.

In accordance with the invention, software authentication methods for software modules requesting or providing resources are advantageously configurable and do not need to be permanently integrated into the respective software module. Such a functionality can therefore be used in the form of a service component and allows fast, flexible and effective use. In accordance with one preferred embodiment of the present invention, to this end the second service has, for each control program module which the second service comprises, a respective dedicated service component for requesting a module identifier, for managing a module identifier encrypted by the control and monitoring unit or for managing a module token ascertained from the module identifier by the authentication service.

Advantageously, the control and monitoring unit is an engineering system for configuring, servicing, starting up and/or documenting the automation system, and the authentication service is provided by the engineering system. This allows particularly fast, secure and efficient configuration of software authentication methods in distributed automation systems which are based on service-oriented architectures. This results in a significant improvement in system security and stability.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below using an exemplary embodiment with reference to the drawing, in which:

FIG. 1 is a flowchart of a method for granting access authorization for a computer-based object in an automation system in accordance with an embodiment of the invention; and

FIG. 2 is a schematic block diagram of an automation system for implementing the method of FIG. 1.

### DETAILED DESCRIPTION OF THE PREFERRED EMBODIMENTS

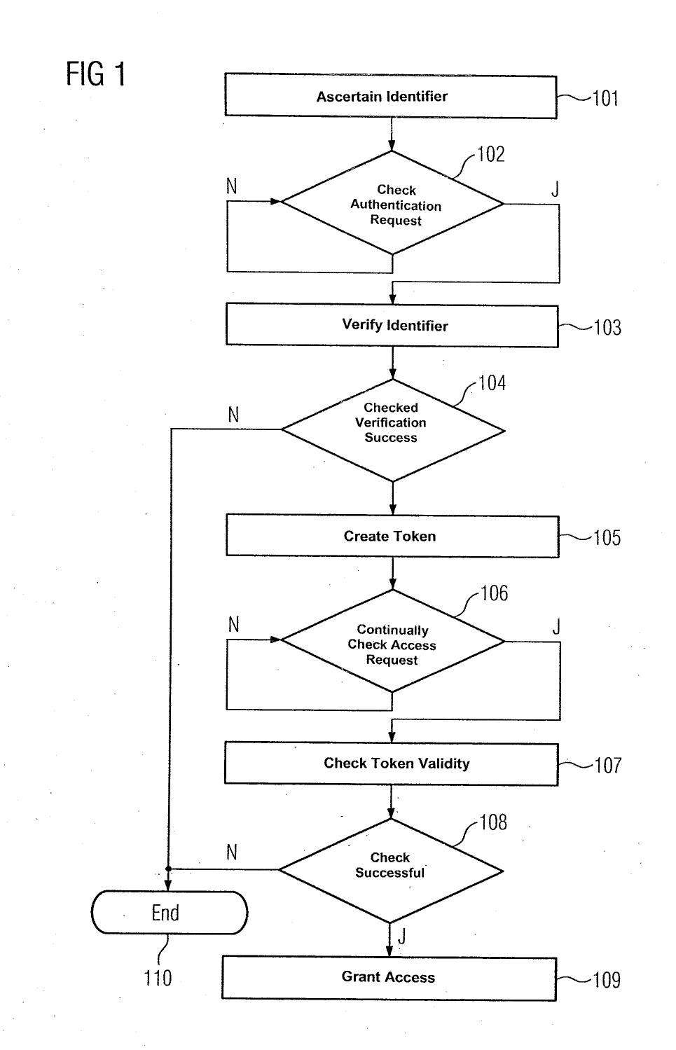

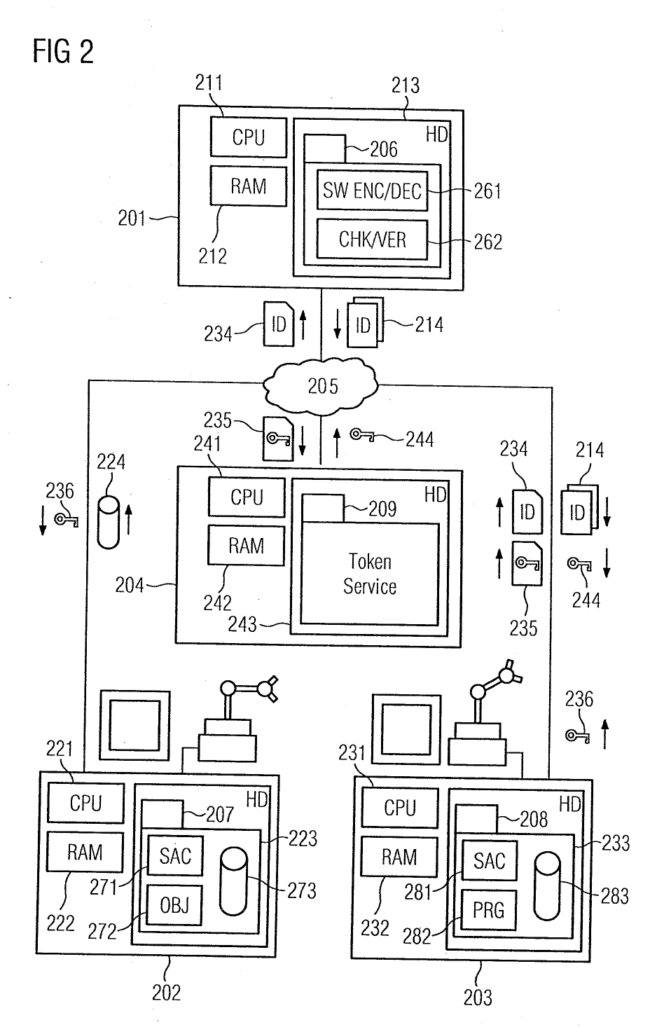

In accordance with the method for granting access authorization for a computer-based object 272 which is illustrated in the flow chart of FIG. 1, an engineering system 201 in the automation system shown in FIG. 2 ascertains a software identifier for a control program 282 (step 101). Furthermore, the software identifier is encrypted using a private digital key associated with the engineering system 201. The engineering system 201 is connected by a communication network 205 to a first computer unit 202, a second computer unit 203 and a third computer unit 204. The first computer unit 202 uses the computer-based object 272 to provide a first service within a service-oriented architecture, while the control program 282 is used to provide a second service. A hard disk 223, 233 in the first and second computer units 202, 203 respectively stores program code 207, 208 for implementing the first and second services. The respective program code 207, 208 comprises the computer-based object 272 and the control program 282 and can be loaded into a main memory 222, 232 in the first and second computer units 202, 203. Furthermore, the respective program code 207, 208 can be executed by a processor 221, 231 in a first and second computer unit 202, 203 for the purpose of providing the first and second services.

In the present exemplary embodiment, the computer-based object 272 is a measurement result that is captured by the first computer unit 202 as a computer-aided sensor unit and is requested by the control program 282 running on the second computer unit 203. The control program 282 is used to actuate metrological or actuator peripherals of the second computer unit 203, such as sensors or robots. For message interchange for the purpose of controlling and monitoring the computer units 202-204, it is necessary to ensure that messages on a path from a transmitter to a receiver are not corrupted.

Otherwise, this corruption could cause faults or damage the automation system. Furthermore, there may be an interest in a measurement result which has been captured because of a sequence by a control program, for example, being able to be requested only by an authorized user and a transmitted message with the measurement result not being able to be intercepted and read by unauthorized users. Here, a user may also be another appliance within the automation system.

The engineering system 201 is used for configuring, servicing, starting up and/or documenting the automation system and provides an identity management service which ascertains and encrypts the identifier. To this end, a hard disk 213 in the engineering system 201 stores program code 206 for implementing the identity management service, which program code can be loaded into a main memory 212 and can be executed by a processor 211 in the engineering system 201. The authentication service comprises a service component for encrypting and decrypting software identifiers and a service component for verifying software identifier requests. Program code 261, 262 for implementing the service components is likewise stored on the hard disk 213 of the engineering system 201.

A hard disk 243 in the third computer unit 204 stores program code 209 for implementing a token service that provides tokens for accessing computer-based objects for control programs. The program code 209 for implementing the token service can be loaded into a main memory 242 in the third computer unit 204 and can be executed by a processor 241 in the third computer unit 204.

The software identifier ascertained and encrypted in line with step 101 of the flowchart shown in FIG. 1 is created by the identity management service upon a message 234 being transmitted from the second computer unit 203 to the engineering system 201 with a request for an encrypted software identifier. When the request has been successfully verified and the encrypted software identifier 214 has been created, the identifier 214 is transmitted to the second computer unit 203, where it is stored in a database 283 associated with the second service and which also comprises information for configuring the second service. Preferably, an unencrypted version of the software identifier is also transmitted to the second computer unit 203 and stored therein.

When the encrypted software identifier has been created and transmitted to the second computer unit 203, the token service continually checks whether there is an authentication request from the second computer unit 203 which comprises a message 235 with a request for a token for the second service for accessing the computer-based object 272 (step 102). A message 235 with a request for a token also comprises the encrypted software identifier. When such a message is transmitted to the token service, the encrypted software identifier is decrypted and verified by appropriate service components of the token service (step 103). This particularly involves the decrypted software identifier being matched against the unencrypted software identifier which the message 235 with the request preferably comprises. In practical application scenarios, there may sometimes be a relatively long period of time between step 102 and step 103.

Subsequently, a check is performed to determine whether verification of the request and of the encrypted software identifier has been successful (step 104). If the result of the verification is negative, the method is terminated in accordance with FIG. 1 in the present exemplary embodiment (step 110). If the verification has been successful, on the other hand, then the token service prompts creation of a token with at least fixed-term validity by the token service and transmission of the token 244 to the second service (step 105). There, the token is stored in the database 283 associated with the second service. Preferably, the second service is configured such that the second service automatically requests a new token from the token service when a validity period for the token 244 expires.

In accordance with the flowchart shown in FIG. 1, step 106 involves a continual check by the first service to determine whether there is an access request for the computer-based object 272. If there is an access request 236 with a token from the second service, the second service checks the token for validity (step 107). Subsequently, step 108 involves a test to determine whether the check has been successful. If the result of the check is negative, the method illustrated in FIG. 1 is terminated (step 110). If the first service is able to perform successful authentication of the control program 282 for the token 236, on the other hand, step 109 involves access to the computer-based object 272 being granted to the control program 282 by an authorization component associated with the first service. In accordance with the present exemplary embodiment, a message 224 comprising the computer-based object 272 is transmitted to the second computer unit 203. Preferably, the access to the computer-based object 272 is granted to the control program 282 only when the encrypted software identifier 214 has been loaded into the main memory 232 of the second computer unit 203 by the control program 282.

The second service has, for each control program module which the second service comprises, a respective dedicated service component for requesting a module identifier, for managing a module identifier encrypted by the control and monitoring unit and/or for managing a module token ascertained from the module identifier by the token service. A program code 281 implementing such a service component is likewise stored on the hard disk 233 of the second computer unit 203. For instances of application in which the first service resorts to other services, an appropriate service component is likewise provided for the first service, the program code 271 of the service component being stored on the hard disk 223 of the first computer unit. Any software identifiers or tokens are stored together with data for configuring the first service in a database 283 associated with the first computer unit 202.

The method described above is implemented on the engineering system preferably by a computer program which can be loaded into a main memory of the engineering system 201. The computer program has at least one code section, the execution of which prompts an identifier to be ascertained for a control program and the identifier to be encrypted using a private digital key associated with a control and monitoring unit for the automation system when the computer program is running in the computer. In this case, the computer-based object can be used to provide a first service, and the control program can be used to provide a second service, from the automation system within a service-oriented architecture. Furthermore, the encrypted identifier is decrypted when it is transmitted to an authentication service and is verified by the authentication service. Furthermore, a token with at least fixed-term validity is transmitted to the second service by the authentication service if verification is successful. Here, the token can be transmitted to the first service for checking and can be checked in order to grant access to the computer-based object to the control program.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1-13. (canceled)

14. A method for granting access authorization for a computer-based object in an automation system, comprising:
ascertaining an identifier for a control program and encrypting the identifier based on a private digital key associated with a control and monitoring unit of the automation system;
providing a first service based on the computer-based object from the automation system, and providing a second service based on control program from the automation system;
decrypting the encrypted identifier upon transmission to an authentication service and verifying the transmitted decrypted the identifier by the authentication service;
transmitting, by the authentication service, a token having at least a fixed-term validity to the second service if verification of the transmitted decrypted the identifier is successful;
transmitting the token via the control program to the first service for checking when access to the computer-based object is requested; and
granting access of the computer-based object to the control program if a result of the checking is positive.

15. The method as claimed in claim 14, wherein the first service and second services are provided within a service-oriented architecture.

16. The method as claimed in claim 14, wherein the access to the computer-based object is granted to the control program by an authorization component associated with the first service if the result of the checking is positive.

17. The method as claimed in claim 15, wherein the access to the computer-based object is granted to the control program by an authorization component associated with the first service if the result of the checking is positive.

18. The method as claimed in claim 14, further comprising:
storing at least one of the encrypted identifier and the token in a database associated with the second service.

19. The method as claimed in claim 18, wherein the database comprises information for configuring the second service.

20. The method as claimed in claim 14, wherein the identifier for the control program is requested by the second service and is ascertained by an identity management service.

21. The method as claimed in claim 20, wherein the control and monitoring unit is an engineering system for at least one of configuring, servicing, starting up and documenting the automation system, and wherein the identity management service is provided by the engineering system.

22. The method as claimed in claim 14, wherein the second service is configurable such that the second service automatically requests a new token from the authentication service when a validity period for the token expires.

23. The method as claimed in claim 14, wherein the encrypted identifier is transmitted to the authentication service as part of a service call initiated by the second service.

24. The method as claimed in claim 14, wherein the token is transmitted to the first service as part of a service call initiated by the second service.

25. The method as claimed in claim 14, wherein the access to the computer-based object is granted to the control program only when the encrypted identifier has been loaded by the control program into a main memory in a computer unit on which the control program is running.

26. The method as claimed in claim 14, wherein the second service has, for each control program module comprised of the second service, a respective dedicated service component for at least one of requesting a module identifier, managing a module identifier encrypted by the control and monitoring unit and managing a module token ascertained by the authentication service from the module identifier.

27. A computer program for granting access authorization loaded into a main memory in a computer and executing on a processor and has at least one code section which, when used on the computer, causes the processor to grant access authorization for a computer-based object in an automation system, the program code comprising:
program code for ascertaining an identifier for a control program and for encrypting the identifier using a private digital key associated with a control and monitoring unit of an automation system when the computer program is running in the computer, the computer-based object being utilizable to provide a first service from the automation system, and the control program being utilizable to provide a second service from the automation system;
program code for decrypting the encrypted identifier upon transmission thereof to an authentication service and for verification by the authentication service; and
program code for transmitting a token with at least fixed-term validity to the second service by the authentication service if verification is successful;
wherein the token is transmittable to the first service for checking and is checkable to grant access to the computer-based object to the control program.

28. An automation system, comprising:
a plurality of computer units of network nodes in the automation system, each of the plurality of computer units being interconnected by a communication network;
at least a first computer unit of the plurality of computer units being configured to provide a first service using a computer-based object and a second service using a control program;
a control and monitoring unit configured to ascertain an identifier for the control program and to encrypt the identifier using a private digital key associated with the control and monitoring unit; and
a second computer unit of the plurality of computer units, associated with an authentication service, being configured to decrypt and verify an encrypted identifier and to transmit a token with at least fixed-term validity to the second service if verification is successful;
wherein the token is transmittable to the first service for checking and is checkable to grant access of the computer-based object to the control program.
